(19) United States
(12) Patent Application Publication
(10) Pub. No.: US 2018/0262747 A1
(43) Pub. Date: Sep. 13, 2018

(54) PORTABLE AUDIO-VIDEO RECORDING DEVICE

(71) Applicant: BIG BOY SYSTEMS, Wavre (BE)

(72) Inventor: Samuel MEIRLAEN, Wavre (BE)

(73) Assignee: BIG BOY SYSTEMS, Wavre (BE)

(21) Appl. No.: 15/756,842

(22) PCT Filed: Aug. 31, 2016
(86) PCT No.: PCT/EP2016/070523

§ 371 Date: Mar. 1, 2018

(30) Foreign Application Priority Data
Sep. 2, 2015 (BE) BE2015/0217

(51) Int. Cl. H04N 13/204; H04R 1/10; H04R 1/08; G02B 27/01; H04N 5/247; H04R 5/027

(52) U.S. Cl. CPC H04N 13/204; H04R 1/10; H04R 1/08; G02B 2027/0138; H04N 5/247; H04R 5/027; G02B 27/0172

(57) ABSTRACT

An audio-video recording device is designed to be worn on the user's head and has a structure that includes a video recorder consisting of two video cameras and a binaural audio recorder consisting of two microphones. The microphones are positioned at the opening of the right ear and the opening of the left ear of the user respectively when the user wears the structure on his or her head. Said device may also include at least one audio earpiece and a controller which is configured to communicate the information about the recording device through the said audio earpiece.

### SCOPE OF THE INVENTION

As per the first aspect, the invention pertains to a portable audio-video recording device with binaural audio. As per the second aspect, the invention pertains to a method for using a portable audio-visual recording device.

### STATE OF THE ART

There are similar recording devices consisting of two cameras, positioned in stereoscopic mode on the eyes of a mannequin head, and a binaural audio recording system consisting of microphones positioned on the ears of this mannequin head. This system is thus used like a “classic” camera and carried by hand. Examples of this system are given in patents JP07264632 and U.S. Pat. No. 1,944,182. The problems with these systems are that, on the one hand, they do not offer a point of view similar to a person's, and on the other hand, the mannequin head is not a true reproduction of a human head, which influences the quality of the binaural audio recording. Moreover, they are cumbersome and not very suitable for use in certain situations like recording action or sports sequences executed by the user.

A partial solution to this problem is proposed in the patent application WO2014162228 which includes an immersive recording system consisting of a support positioned on the user's head (headgear). This support has two movable cameras mounted on rails (one vertical, one horizontal). It also includes 4 microphones (two to the right, two to the left) for binaural recording. These microphones are located on the headgear above the user's ears.

Though this system improves upon the situation described in patents JP07264632 and U.S. Pat. No. 1,944,182, it does have several problems. First of all, the audio recording is not strictly speaking a binaural recording because the microphones are not positioned between the users' auditory canals. Then, there is no effective method for the user to operate the device when it is positioned on his or her head. Actually, the user cannot check whether the device is recording, or if the batteries are sufficiently charged, or if there is any other problem.

One of the purposes of the invention is to achieve a high quality binaural audio recording, and the audio recording should be synced with the video recording such that the recording is done first, and then the user's experience is transposed with more fidelity than the current devices. Another purpose of the invention is to provide a method for communication between the device and the user.

### SUMMARY OF THE INVENTION

The invention is defined through independent claims. The dependent claims define the preferred methods of operation of the invention.

One of the purposes of the invention is to at least partially resolve the problems of portable audio-visual recording devices, which can be positioned on the user's head, consisting of a video recording system and a binaural audio recording system. In particular, one purpose of the invention is to provide a device which can achieve high quality binaural sound recording, coupled with stereoscopic video recording.

As per the first aspect, the invention pertains to an audio-video recording device with a structure designed to be worn on the user's head. This structure includes a video recorder and a binaural audio recorder. The video recorder consists of two video cameras, each one capable of generating a video signal and a device for recording the video signal. The binaural audio recorder consists of two microphones, each capable of generating an audio signal, and a device for recording audio signals. This device is characterised in that each of the two microphones is connected to the said structure such that one can be positioned at the opening of the said user's right ear (120), and the other can be positioned at the opening of the said user's left ear (120), when the user (120) wears the device on his or her head. The video recorder of the device is a stereoscopic video recorder and it includes two video cameras, each capable of generating a video signal and which are attached to the structure such that their respective fields of vision overlap each other, at least partially. Preferably, the optical axes of the cameras in the device are parallel to one another, and the fields of vision of both cameras overlap at least partially, thus allowing the stereoscopic recording of a video stream. The purpose of the invention is achieved because the structure of the device in the invention allows placing the microphones respectively at the opening of the right and the left ears of the user when the user is wearing the device on the head, while the presence of two video cameras allows reproducing the user's stereoscopic vision.

In another preferred version of the device in accordance with the invention, the said device also includes at least one audio earpiece and a controller which is configured to communicate the information about the recording device to the user through the said audio earpiece (at least one). Preferably, this earpiece will be a bone conduction earpiece which allows reducing interference with the binaural audio recorder and to leave the user's auditory canal open. Preferably, the device will include two bone conduction audio earpieces.

This allows achieving another one of the invention's purposes which is to provide a means for communication between the device and the user via transmission of information concerning the device through the earpieces and thus allowing the user to not have to remove the device from his or her head to check if it is still working.

Preferably, the device includes a band-stop filter which filters a frequency band of the audio signals originating from each of the two microphones.

In an ideal version of the invention, both cameras are movably mounted on the structure, and the device has a motorization which is configured to move the optical axes of the said cameras towards or away from one another.

In another ideal version, the said device includes a mechanism for gauging the distance between an element in the shared field of vision of the two cameras and a reference point on the device. Moreover, the controller is configured to control the motorization to move the optical axes of the cameras towards or away from one another depending on the said distance. Preferably, this deviation increases when the distance between an element in the shared field of vision of both cameras and a point of reference on the device increases and decreases when the said distance decreases.

Preferably, the mechanism for gauging the distance between an element in the shared field of vision of both cameras and a point of reference on the device include a laser mounted on the structure such that its light beam points towards the direction of the shared field of vision of both cameras. Preferably, the laser is mounted on the structure between the optical axes of both cameras. In an even more ideal situation, the laser is mounted on the structure half-way between both cameras.

The aforementioned characteristics allow adjusting the distance between the optical axes of both cameras, which improves the stereoscopic effect.

Preferably, the device includes at least two batteries and the controller is configured to handle at least two batteries. The presence of two batteries allows a seamless recording by providing the option of swapping one of the two batteries without the device being shut down.

As per the second aspect, the invention pertains to a method for use of an audio-video recording device such as described above. This method includes the following steps:
a) provision of an audio-video recording device such as described above:
b) placing the structure on the user's head, ensuring that the cameras are on the frontal part of the user's skull.
c) positioning both microphones such that one microphone is at least partially inside the pinna of the user's right ear, and the other is positioned at least partially in the pinna of the user's left ear.

Preferably, one of the microphones is positioned between the user's right tragus and right antitragus, and the other between the user's left tragus and left antitragus.

In case the device contains at least one bone conduction earpiece, the method may also include the following step: positioning of the bone conduction earpieces on the right and/or left temple of the user.

As per the third aspect, the invention pertains to a video recording device with a structure designed to be worn on the user's head. This structure includes:

a) a stereoscopic video recorder which includes:
a. two video cameras movably mounted on the structure, of which the shared fields of vision overlap at least partially and both of which are capable of generating a video signal;
b. a video signals recording device;

b) a motorization configured to move the optical axes of the said cameras towards or away from one another;

this device is characterised in that it includes mechanisms for gauging the distance between an element in the shared field of vision of the two cameras and a reference point on the device and in that the device includes a controller configured to gauge this distance.

Preferably, the controller is configured to control the motorization to move the optical axes of the cameras towards or away from one another depending on the said distance. Preferably, the optical axes of the cameras are moved further from one another when the distance increases and they move closer to one another when the distance reduces.

Preferably, the mechanism for gauging the distance between an element in the shared field of vision of both cameras and a point of reference on the device include a laser mounted on the structure such that its light beam points towards the direction of the shared field of vision of both cameras. Preferably, the laser is mounted on the structure between the optical axes of both cameras. In an even more ideal situation, the laser is mounted on the structure half-way between the optical axes of both cameras.

Preferably, the optical axes of the cameras in the device are parallel to one another.

The aforementioned characteristics allow automatically adjusting the distance between the optical axes of both cameras, which improves the stereoscopic effect.

As per a third aspect, the invention pertains to a method for adjusting the distance between the optical axes of cameras in one of the abovementioned devices. This method includes the following steps:
a) the controller switches on the laser;
b) the laser lights an element located in the shared field of vision of two cameras;
c) the controller measures the distance between the element lit by the laser and a point of reference on the device, and this measurement takes place as follows:
   a. determination of the respective positions of the image of the laser point on the element and the respective sensors of both cameras; or in other words; determination by the video sensors (431, 432) of both cameras (131, 132) of the respective positions of the image of the laser point (170) reflecting on the targeted element (420);
   b. calculation of angles between the beams from the laser point image on the element and optical axes of the cameras;
   c. determination of the distance depending on the distance between a point of reference on the right side camera sensor and a point of reference on the left side camera sensor.
d) the controller calculates a distance between the cameras based on a pre-determined calibration and it controls the motorization for:
   a. move the optical axes away from one another if the distance exceeds a pre-determined threshold:
   b. move the cameras closer to one another if the distance goes below a second pre-determined threshold.

### BRIEF DESCRIPTION OF THE FIGURES

These aspects, along with the other aspects of the invention, will be clarified in the detailed description of the special methods of operation of the invention, with references to the drawings, in which:

FIG. 1 is a front view of a device in accordance with the invention;

FIG. 2 is a left profile view of a device in accordance with the invention;

FIG. 3 is a detailed view of the video component of a device in accordance with the invention;

FIG. 4 is a diagram showing the object-cameras distance gauging mechanism;

FIG. 5 is a detailed view of the audio component (earpieces) of a device in accordance with the invention;

FIG. 6 is a detailed view of the audio component (microphones) of a device in accordance with the invention;

FIG. 7 is a rear view of a device in accordance with the invention;

FIG. 8 is a front view of an alternative device in accordance with the invention;

The drawings are not to scale. Generally, similar elements are denoted using similar references in the figures. The presence of reference numbers in the diagrams cannot be considered restrictive, including when the numbers are indicated in the claims.

### DETAILED DESCRIPTION OF THE SPECIAL METHODS OF OPERATION

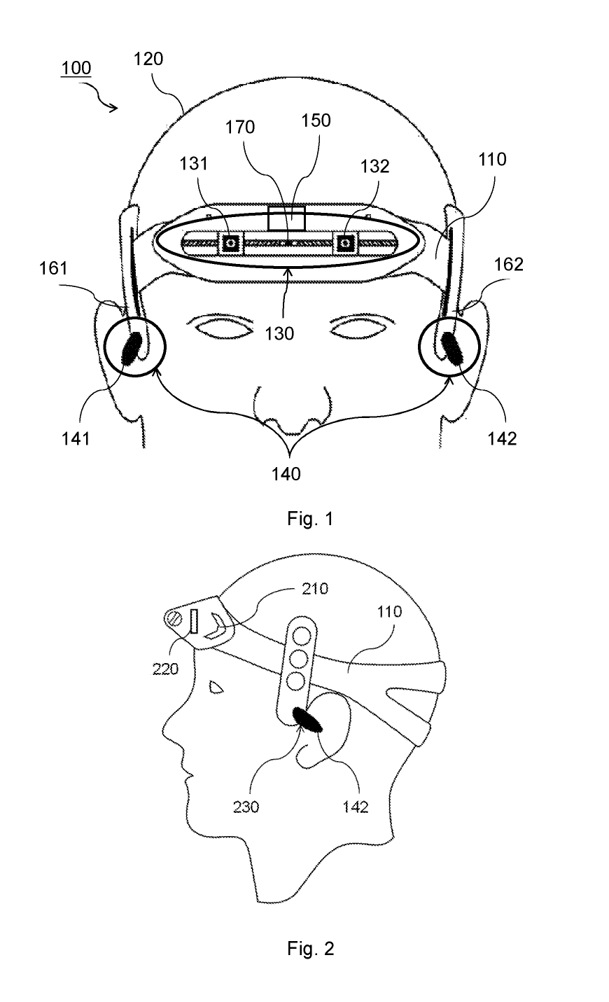

FIG. 1 shows an example of a front view of a device 100 in accordance with the invention. This device 100 includes a structure 110 designed to be worn on the user's head 120. This structure is, for example, an adjustable and/or elastic band, or any other type of headgear: headset, cap, hat, or any equivalent or similar product.

The structure 110 supports the other components of the device 100 and includes a video recorder 130, a binaural audio recorder 140 and a controller 150. Preferably, it also includes at least some of the following elements: an earpiece 161, a battery 210 (FIG. 2), a recording medium 220 (FIG. 2), an inter-lens distance adjustment system, a laser 170, and the electronics in the device 100. For example, these elements are attached to the structure 110 using fastening devices such as: a notch which accommodates a band, a self-gripping strip, a clip, a strap, elastic, a self-adhesive strip, a button, a press-button, a rivet, a screw, a bolt, a nut, a stitch, a weld, glue, a pivot, a hook, a hook and loop system (Velcro®), a sliding system, a magnet, or any equivalent mechanism.

Ideally, the recording medium 220 is a hard disk, RAM memory, or “flash” memory. Preferably, this medium 220 is a “flash” memory medium.

The video recorder 130 is a stereoscopic video recorder which includes two cameras: a right side camera 131 and a left side camera 132. Preferably, the video recorder 130 is mounted on the front part of the structure 110, i.e. the part near the user's face 120 when the latter wears the device 100 on his or her head. Preferably, the cameras 131, 132 have a “fisheye” lens, which is known to persons skilled in the art. These lenses have a special feature, which is their ultra wide field angle, ranging up to 170° or even 180°. Preferably, the focal length of the cameras 131, 132 is infinite. It is generally known that this focal length also offers the advantage of deleting the blurred zones in the image. Preferably, the cameras 131, 132 are fitted with a CMOS sensor. Alternatively, any other type of video recorder, like the CCD or Foveon may be used. Preferably, the resolution of the cameras 131, 132 is 720p with a frame rate of 30 frames per second (30 FPS). In an even more ideal situation, the resolution is 1080p with a frame rate of 60 frames per second (60 FPS). Alternatively, any other standard (240p, 360p, 480p, 2160p, 4320p) with a frame rate of 24, 60, 100 frames per second (24, 60, 100 FPS) could be used. For example, the cameras 231, 232 may be of the type Ambarella A7LS—High-Performance 1080p60 Sports Camera SoC.

The binaural audio recorder 140 includes a right microphone 141 and a left microphone 142. Preferably, the microphones 141, 142 are lavalier microphones, which are known to persons skilled in the art. These microphones are known to have a good response to high sound pressure levels and to retain good levels of sensitivity at low sound pressures. For example, the microphones 141, 142 are phantom-powered omnidirectional miniature condenser microphones of which the voltage may be between 1 V and 60 V. A phantom power supply is known to persons skilled in the art and allows connecting ordinary cables to microphones which need electrical current. Preferably, the voltage is between 5V and 48V. The microphones 141, 142 may be sweat and moisture resistant. Preferably, they are between 2 and 20 mm in size. In an even more ideal situation their size is between 4 and 10 mm. The microphones 141, 142, may be, for example, DPA 4061, DPA 4060, Countryman B3 or Sennheiser Mke1 microphones. Preferably, microphones 141, 142, are DPA 4061 microphones.

Lastly, the structure 110 includes a controller 150, preferably positioned on the front part of the structure 110 of the device 100. The controller 150 is configured to manage the video recorder 130 and to manage the audio recorder 140.

The controller is also preferably configured to control and manage the phantom power supply of the microphones 141, 142 and the power supply for the cameras 131, 132. Preferably, it may be configured to manage the charge level of the battery 210.

The controller may include an Ambarella A7LS chip for processing images and camera options, or any other equivalent chip, known to the persons skilled in the art, may be used. It may also include an ARM processor or an equivalent processor known to the persons skilled in the art. A video encoding chip (for example h264, h265, vp8, or vp9 formats) may also be added.

In a preferred version of the device in accordance with the invention, structure 110 also includes at least one earpiece 161. Preferably, the structure 110 includes two earpieces 161, 162 which are bone conduction earpieces in an even more preferable version of the invention. This type of earpiece functions similarly to a conventional audio earpiece. Nevertheless, in a conventional audio earpiece, a moving coil is connected to a thin membrane which converts the mechanical movement into an acoustic signal. In case of a bone conduction earpiece, this membrane is replaced with a rigid material, for example, a piece of steel. This rigid part thus propagates vibrations at an intensity which is not sufficient to create a perceptible acoustic field in the air, but which once in position, preferably against the temple of a user, propagates mechanical vibrations to the bones in the user's skull. The inner ear perceives these vibrations and communicates them to the cochlea. This type of earpiece is known to persons skilled in the art.

The advantages of these bone conduction earpieces are their water resistance because the earpiece may be enclosed in a hermetically sealed case and the fact that they do not impede the user's normal hearing since they do not block the auditory canal.

Moreover, using a conventional earpiece near the microphones 141, 142 would risk causing a Larsen effect, which does not happen if bone conduction earpieces are used. Moreover, using conventional earpieces would require sending back an audio signal recorded in real time to the listener to make up for the audio loss. Latency during conversion of the signal is a potential source of problems for the user.

Alternatively, the earpieces 161, 162 will be able to play a digital audio track imported by the user 120.

In the preferred version of the device in accordance with the invention in which the structure 110 also includes at least once earpiece 161, the controller is also preferably configured to control and manage the power supply of the earpieces. The controller is also configured to generate and communicate to the user 120 information concerning the recording device via at least one earpiece 161. Preferably, the controller communicates information via the earpieces 161, 162. This information concerns, for example, the status of the device 100 such as the whether or not the cameras are recording 131, 132, the battery level of at least one battery 210, or even provide a method of operation for the device 100.

This information may also concern the status of the recording medium 220, the remaining recording time, the adjustment of the distance between the cameras 131, 132, or any other information useful for using the device 100.

Preferably, the controller may generate audio signals and/or a digital voice. Preferably, these audio signals and/or voice are transmitted on a narrow frequency band, at a bandwidth lower than 500 Hz. Preferably the bandwidth is lower than 100 Hz. Ideally the bandwidth is lower than 20 Hz. In an ideal case, the audio signals and voice are mono-frequency and are transmitted at 1000 Hz even though any other central frequency audible to humans may be used. The term audio signal means a very short and artificially generated sound, like a “beep”.

These audio signals and/or digital voices may be captured by the microphones 141, 142 and thus may cause problems. It may thus be useful to filter them. Preferably, the controller is configured to filter audio signals and/or digital voices during the recording using a band-stop filter of a bandwidth corresponding to the bandwidth of the transmitted sounds. Preferably, this filtering is done in real time when audio information is transmitted through the earpieces 161, 162.

FIG. 2 shows a left profile view of the device 100 according to a method of operation of the invention. Structure 110 includes the means 230 for positioning the microphones 141, 142, one at the opening of the right ear of the said user 120, and the other at the opening of the left ear of the said user 120, when the user 120 wears the device on his or her head. Preferably, the microphones 141, 142 are positioned such that one is between the right tragus and antitragus of the user 120, the other is between the left tragus and antitragus of the user 120, when the user 120 wears the device on his or her head.

When they are positioned such, the microphones 141, 142 do not obstruct the user's auditory canal 120 and thus do not impede hearing. Moreover, the microphones 141, 142 are thus positioned at the same place as an earpiece or headset which would be used when playing back the recording, thus making it a binaural recording as regards its quality.

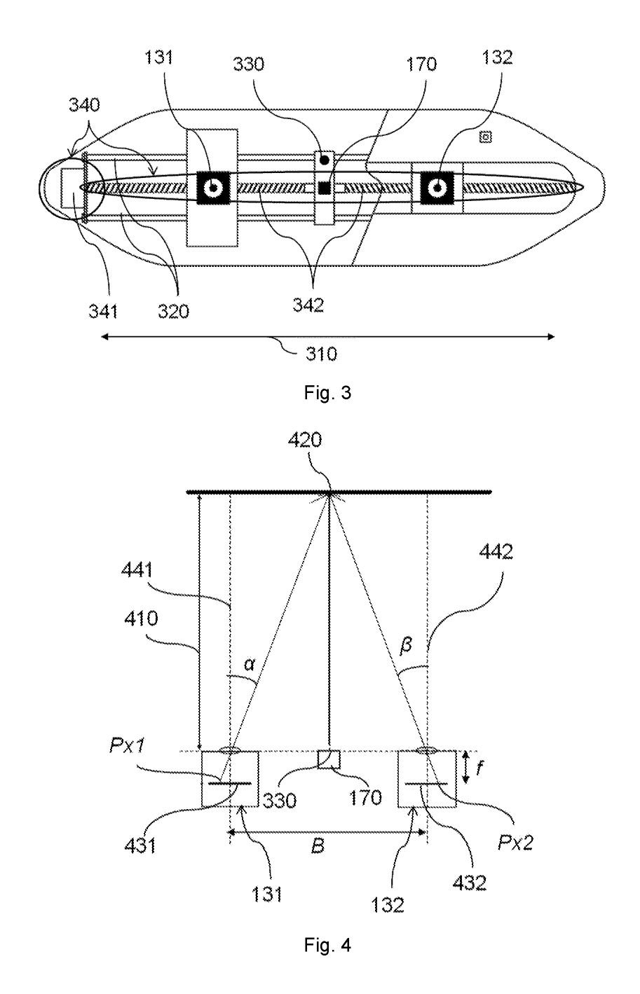

FIG. 3 shows a detailed view of the video recorder 130. According to a general method of operation, the video recorder includes two cameras 131, 132. Preferably, the cameras 131, 132 have their optical axes parallel to one another.

Preferably, the cameras 131, 132 are movably mounted on the structure and in the direction indicated by the double arrow 310. Preferably, the cameras 131, 132 are mounted on a rail 320. The device 100 also has motorized mechanisms to ensure that the optical axes of the cameras 131, 132 can more away from or towards one another. These mechanisms are, for example, a motorization 340 including a servo-motor 341 and a double threaded reverse pitch screw or rod 342. Alternatively, the motorization 340 may include two screws and two servo-motors. Alternatively, the motors may be linear, synchronous, or asynchronous electric motors. The motorization 340 may include a system of pulley and cables, springs, or any means that allow linear displacement.

Preferably, the cameras 131, 132 pivot together around an axis lying on the plane formed by the optical axes of the cameras 131, 132, since this axis is perpendicular to the said optical axes. Preferably, this axis passes through the central points of the sensors of the cameras 131, 132. The angle of the cameras 131, 132 is adjusted, for example, by a roller located on the right or left extremity of the rail 320. This adjustment allows filming high angle or low angle shots without the user 120 having to incline the head when wearing the device 100 on the head.

Preferably, the device 100 also includes a mechanism for gauging the distance between an element in the shared field of vision of the two cameras 131, 132 and a reference point on the device 100. Preferably, the reference point 330 is located half-way between the cameras 131, 132.

In a preferred version of the invention, the mechanism for gauging the distance between an element in the shared field of vision of both cameras 131, 132 and a point of reference 330 on the device 100 include a laser 170 mounted on the structure 110 such that its light beam points towards the direction of the shared field of vision of both cameras 131, 132. Preferably, the laser 170 is mounted on the structure 110 half-way between the optical axes of both cameras 131, 132. In an even more ideal situation, the laser 190 is mounted on the structure 110 half-way between the optical axes of both cameras 131, 132.

FIG. 4 illustrates the gauging of the distance 410 between an element in the shared field of vision of the two cameras 131, 132 and a reference point on the device 100. The laser 170, is switched on and focused on an element 420 of the shared field of the cameras 131, 132. The reflection of the laser on the element 420 constitutes the brightest point in the field. The controller 150 is configured to determine the brightest pixel in each image captured by the cameras 131, 132. These pixels correspond to physical points on the sensors 431, 432, of the cameras 131, 132. Knowing the focal length (f) of the cameras 131, 132, the distance (dc1 and dc2) between the respective optical axes 441, 442, of the cameras 131, 132 and the physical points corresponding to the brightest pixels (Px1 and Px2), the angles α and β are calculated:

$$α = {tan}^{- 1} \frac{d c 1}{f} and β = {tan}^{- 1} \frac{d c 2}{f} \qquad ( I )$$

Then, knowing the distance (B) between the cameras, and taking into account the relations in various triangles, it is possible to calculate the distance 410 (D):

$$D = B \frac{cos α cos β}{sin ( α + β )} \qquad ( II )$$

Once the distance 410 is gauged, the controller 150 is configured to send a command to the motorization 340 to adjust the distance between the cameras 131, 132 by making them move length-wise along the rail 320 in the direction 310. Preferably, this distance between the cameras depends on the distance 410: the motorization 340 moves the cameras 131, 132 apart when the distance increases and the motorization 340 moves the cameras 131, 132 closer when the distance reduces. Alternatively, the lens of the video cameras 131, 132 may be movable, for example using movable prisms which are moved by the motorization 340 in a similar manner to the movement of the optical axes of the video cameras 131, 132.

This adjustment of the distance between the cameras 131, 132 allows changing the shooting according to the depth of field of the subject being filmed. Adjusting the distance between the cameras 131, 132 allows resolving two problems frequently encountered when using 3D cameras: firstly, distant objects lose depth rendering if the distance between the cameras 131, 132 is too small in relation to the camera-object distance; secondly, if the object is too close to the lens, and if the distance between the cameras 131, 132 is the same as the distance between the cameras 131, 132 and the object, it is likely that the subject will be lost from the viewing angle of one of the two lens, which would result in loss of stereoscopy.

The link between the adjustment of the distance between the optical axes of the cameras 131, 132 and the distance 410 may be determined as per the following method:

a) Minimum comfortable distance:
the distance between the optical axes of the cameras 131, 132 is set to a value E₀;
the cameras 131, 132 are powered on and recording;
an object is placed at a distance longer than 1 metre, preferably longer than 4 metres;
the object is moved nearer till it reaches the minimum distance at which the fields of vision of both cameras 131, 132 start to overlap;
the recorded stereoscopic sequence is viewed by at least one person;
at least one person defines the minimum distance at which he or she starts experiencing eye fatigue;
the procedure is repeated for a distance between the optical axes of the cameras 131, 132 set to a value E₁ which is different than E₀.

b) Maximum comfortable distance:
the distance between the optical axes of the cameras 131, 132 is set to a value E₀;
the cameras 131, 132 are powered on and recording;
a first object is placed at a distance longer than 2 metres, preferably longer than or equal to 4 metres;
a second object, identical to the first object, is moved nearer to the first object starting from the minimum distance at which the fields of vision of both cameras 131, 132 start to overlap;
the recorded stereoscopic sequence is viewed by at least one person;
at least one person defines the maximum distance at which he or she can no longer define which of the two objects is closer to the cameras 131, 132;
the procedure is repeated for a distance between the optical axes of the cameras 131, 132 set to a value E₁ which is different than E₀.
   These measurements provide the usage intervals of the device in accordance with the invention for a given distance between the optical axes of the cameras 131, 132. Preferably, a curve interpolated based on the average distances of these intervals serves as the calibration curve and is used to adjust the distance between the optical axes of the cameras 131, 132 according to the distance 410.

For example, a sequence of adjusting the distance between the cameras 131, 132 consists of the following steps:
The controller 150 lights the laser 170;
The controller 150 detects the point where the laser is reflected on an element 420 in the shared field of the cameras 131, 132 on the respective sensors 431, 432 of the cameras 131, 132;
The controller measures the physical position of the point on the respective sensors of the cameras 131, 132 in relation to the respective optical axes 441, 442, of the cameras 131, 132;
The controller calculates the angles α and β depending on the known focal length f of the cameras 131, 132 and according to equation 1;
The controller gauges the distance 410 according to equation 2;
The controller sends a command to the motorization 340 to set the distance between the cameras 131, 132.

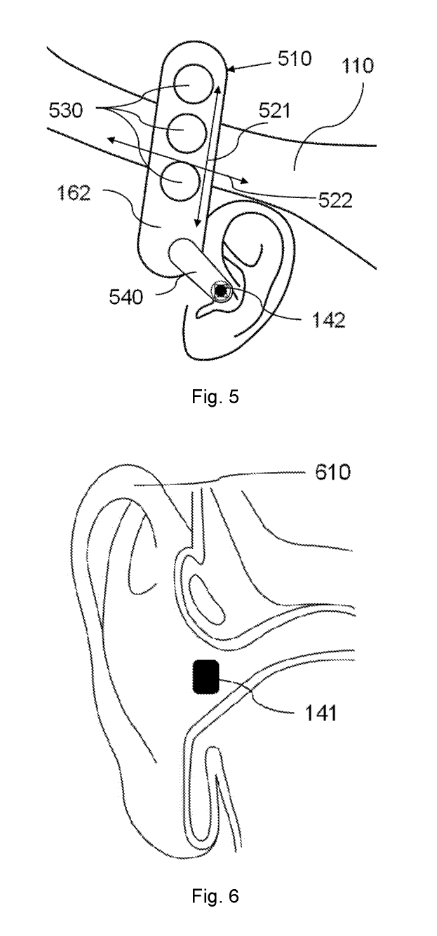

FIG. 5 shows a detailed view of an earpiece 161 (or 162) and a microphone 141 (or 142). In a preferred version of the device in accordance with the invention, the earpieces 161 and/or 162 are bone conduction earpieces. Preferably, the earpieces 161, 162 are movably mounted on the structure 110. For example, the earpieces are positioned on the sides of the structure 110, i.e. the part of the structure 110 between the front part, such as defined above, of the structure 110 and the part of the structure 110 located behind the user's head 120 when he or she is wearing the device 100 on the head (rear of the structure 110). Preferably, the earpieces 161, 162 are placed in a 510 of the structure 110. Preferably, this module 510 is capable of pivoting around its point of connection to the structure 110. Preferably, it can also move in any of the directions 521, 522 so that the earpieces 151, 152 can be positioned on the right temple and the left temple of the user 120 respectively while he or she is wearing the device 100 on the head. For example, the module 510 has a slot through which a portion of the structure 110 may pass such that the module slides in the directions 521 and 522.

Preferably, the module 510 is made of hard and rigid plastic. In addition, the part that comes in contact with the skin of the user 120 may be covered with a soft material to ensure better comfort for the user 120.

Preferably, the module 510 includes buttons 530. These buttons 530 are, for example, push buttons. The buttons 530 allow sending instructions to the controller 150 like starting or stopping the recording, powering on or switching off the device 100, or even adjusting the volume of the audio information sent by the controller 150 and transmitted through the earpieces 161, 162.

FIG. 6 shows the right side microphone 141. Preferably, the microphones 141, 142 are connected to the structure 110 in order to facilitate their optimal positioning to ensure high quality binaural recording, i.e. respectively at the openings of the right ear 610 and the left ear of the user 120 or, preferably, between the right and left tragus and antitragus of the user 120 respectively. Preferably, the earpieces are connected to the structure 110 through the module 510 and are mounted on the distal extremity of an arm 540 which pivots around a point of connection with the module 510. Preferably, this arm 540 is flexible and can, for example, dampen the manipulation noises and impacts.

Preferably, the device 100 in accordance with the invention may include a wireless transmitter or a transmitter/receiver.

In a preferred version, the device in accordance with the invention includes at least one battery 210 which is located, for example, behind the cameras 131, 132. Alternatively, the battery 210 may be placed behind the structure 110. Preferably, the device includes two batteries, one of which is located behind the right side camera 131, and the other is located behind the left side camera 132. Alternatively, the battery 210 or the batteries may be located behind the structure 110 or at any location on the structure 110.

Preferably, the controller 150 is configured to manage the charge level of the battery or batteries. For example, the controller may use one of the two batteries, then, when the charge level is low, inform the user 120 about this via the earpieces 161, 162. It can then send a command to start using the other battery. The user 120 may also replace the first discharged battery. It is thus possible to continue recording without interruption.

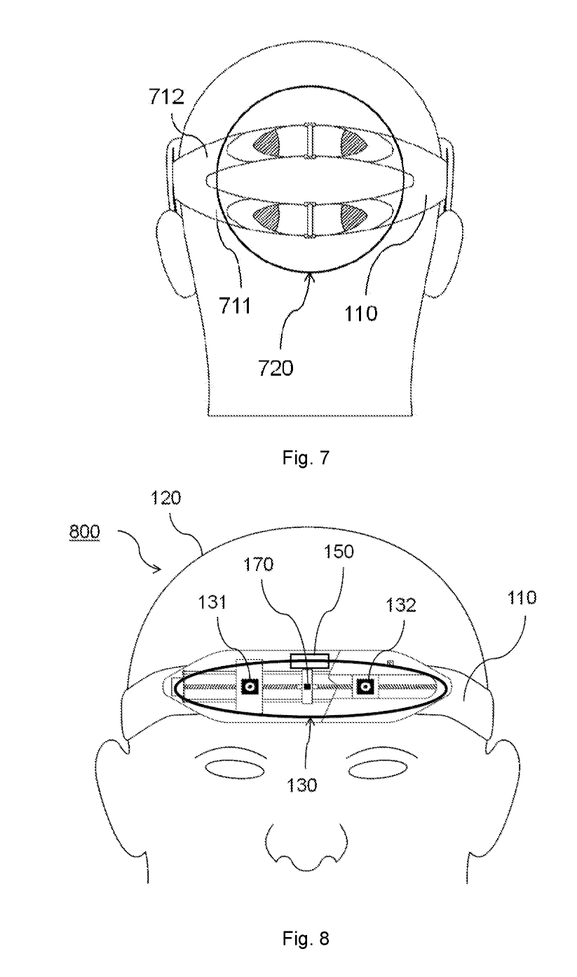

FIG. 7 shows a rear view of the device 100. The structure 110 of the device 100 is preferably attached to a band.

Preferably, the rear of the band is split into two strips 711, 712 ensuring a better grip on the head of the user 120. Preferably, the angle formed by the strips 711, 712 is between 10° and 90°. In an even more ideal situation, the angle is between 30° and 60°.

Preferably, the band is made of a textile and ideally elastic material. Alternatively, the band consists of a portion 720 which is adjustable in length so that it can be adjusted to the head of the user 120. Preferably, this portion 720 is located on the rear part of the band 120 which makes the adjustment process easier. For example, the length of this portion 720 may be changed using a system of hooks and loops (self-gripping strip, also known as Velcro®), straps, or any other mechanism known to persons skilled in the art. Preferably, this portion is elastic. Preferably, the textile material used is neoprene.

FIG. 8 shows an alternative version of the device 800 in accordance with the invention. This device 800 includes a structure 110 designed to be worn on the user's head 120. This structure is, for example, an adjustable and/or elastic band, or any other type of headgear: headset, cap, hat, or any equivalent or similar product.

The structure 110 supports the other components of the device 800 and includes stereoscopic a video recorder 130 and a controller 150. Preferably, it also includes at least one of the following elements: a binaural audio recorder 140 (FIG. 1), an earpiece 161 (FIG. 1), a battery 210 (FIG. 2), a recording medium 220 (FIG. 2), an inter-lens distance adjustment system, a laser 170, and the electronics in the device 800.

For example, these elements are attached to the structure 110 using fastening devices such as: a notch which accommodates a strip, a self-gripping strip, a clip, a strap, elastic, a self-adhesive strip, a button, a press-button, a rivet, a screw, a bolt, a nut, a stitch, a weld, glue, a pivot, a hook, a hook and loop system (Velcro®), a sliding system, a magnet, or any equivalent mechanism.

The stereoscopic video recorder includes two cameras: a right side camera 131 and a left side camera 132. Preferably, the video recorder 130 is mounted on the front part of the structure 110, i.e. the part near the user's face 120 when the latter wears the device 100 on his or her head. Preferably, the cameras 131, 132 have a “fisheye” lens, which is known to persons skilled in the art. These lens have a special feature, which is their ultra wide field angle, ranging up to 170° or even 180°. Preferably, the focal length of the cameras 131, 132 is infinite. It is generally known that this focal length also offers the advantage of deleting the blurred zones in the image. Preferably, the cameras 131, 132 are fitted with a CMOS sensor. Alternatively, any other type of video recorder, like the CCD or Foveon may be used. Preferably, the resolution of the cameras 131, 132 is 720p with a frame rate of 30 frames per second (30 FPS).

In an even more ideal situation, the resolution is 1080p with a frame rate of 60 frames per second (60 FPS). Alternatively, any other standard (240p, 360p, 480p, 2160p, 4320p) with a frame rate of 24, 60, 100 frames per second (24, 60, 100 FPS) could be used. For example, the cameras 231, 232 may be of the type Ambarella A7LS—High-Performance 1080p60 Sports Camera SoC.

Lastly, the structure 110 includes a controller 150, preferably positioned on the front part of the structure 110 of the device 100. The controller 150 is configured to manage the video recorder 130 and to manage the power supply of the cameras 131, 132. We shall refer to the earlier paragraphs regarding the definition of managing the video recording 130 and the power supply of the cameras 131, 132.

The controller may include an Ambarella A7LS chip for processing images and camera options, or any other equivalent chip, known to the persons skilled in the art, may be used. It may also include an ARM processor or an equivalent processor known to the persons skilled in the art. A video encoding chip (for example h264, h265, vp8, or vp9 formats) may also be added.

Preferably, the video recorder includes the characteristics described in the paragraphs [0038] to [0046].

To summarise, the invention may also be described as follows: an audio-video recording device with a structure designed to be worn on the user's head. This structure includes a stereoscopic video recorder consisting of two video cameras and a binaural audio recorder consisting of two microphones.

This device is characterised in that the microphones are positioned at the opening of the right ear and the opening of the left ear of the user respectively. This device may also include two audio earpieces and the controller is then configured to communicate to the user information concerning the recording device via these audio earpieces.

1. A device configured for audio-video recording, including a structure designed to be worn on the user's head, the said structure comprising:
a) a video recorder mounted on the structure and including:
a. two video cameras, each capable of generating a video signal, wherein said two video cameras are mounted on the such that their respective fields of vision overlap each other, at least partially;
b. a recording device for the said video signal;
b) a binaural audio recorder amounted on the structure and including:
a. two microphones, each capable of generating an audio signal;
b. a recording device for the said audio signals;
wherein each of the two microphones is connected to the said structure such that one is or can be positioned at the opening of the said user's right ear, and the other is or can be positioned at the opening of the said user's left ear, when the user wears the structure on his or her head.

2. The device according to claim 1, further comprising at least one audio earpiece and a controller configured to communicate the information about the recording device to the user through the at least one audio earpiece.

3. The device according to claim 2, further comprising a band-stop filter that filters a frequency band of the audio signals originating from each of the two microphones.

4. The device according to claim 2, wherein the at least one audio earpiece is a bone conduction earpiece.

5. The device according to claim 1, wherein the two cameras have their optical axes parallel to one another.

6. The device according to claim 5, wherein both cameras are movably mounted on the structure, and the device has a motorization that is configured to move the optical axes of the said cameras or the lens of the said cameras towards or away from one another.

7. The device according to claim 6, wherein the device includes a mechanism for gauging the distance between an element in the shared field of vision of the two cameras and a reference point on the device and that the controller is configured to send a command to the motorization to move the optical axes of the two cameras away from one another when the said distance increases, and to move the optical axes of the two cameras towards one another when the said distance decreases.

8. The device according to claim 7, wherein the mechanism for gauging the distance between an element in the shared field of vision of both cameras and a point of reference on the device include a laser mounted on the structure such that its light beam points towards the direction of the shared field of vision of both cameras.

9. The device according to claim 8, wherein the laser is mounted on the structure half-way between the optical axes of both cameras.

10. The device according to claim 8, wherein each of the video cameras also consist of a video recorder.

11. The device according to claim 1, further comprising at least two batteries and a controller configured to control the power supply of the at least two batteries.

12. A method comprising:
a) obtaining the device according to claim 1;
b) positioning the structure on a user's head, and positioning that the cameras are on the frontal part of the user's skull;
c) positioning both microphones such that one microphone is positioned at least partially near the opening of the user's right ear, and the other microphone is positioned at least partially near the opening of the user's left ear.

13. The method according to claim 12, in which, in c), the microphones are positioned such that one is between the right tragus and antitragus of the user, the other is between the left tragus and antitragus of the user.

14. The method according to claim 12, in which a) is obtaining the device including a bone conduction earpiece, and the method consists of positioning the bone conduction earpiece on the right or left temple of the user.

15. A method of adjusting a distance between the optical axes of the cameras of the device according to claim 10, the method comprising:
a) switching on the laser (170) via the controller;
b) lighting an element, with the laser, that is located in the shared field of vision of two cameras;
c) measuring, with the controller, a distance between the element lit by the laser and a point of reference on the device, and this measurement takes place as follows:
a. determination by the video sensors of both cameras of the respective positions of the image of the laser point reflecting on the targeted element;
b. calculation of respective angles between the light beams from the laser point image on the element and respective optical axes of the cameras;
c. determination of the distance depending on the distance between a point of reference on the right side camera sensor and a point of reference on the left side camera sensor;
d) calculating, with the controller, a distance between the cameras based on a pre-determined calibration and controlling, with the controller, motorization for:
a. moving the optical axes away from one another if the distance exceeds a pre-determined threshold, and/or
b. moving the cameras closer to one another if the distance goes below a second pre-determined threshold.
